(19) United States
(12) Patent Application Publication
(10) Pub. No.: US 2024/0302008 A1
(43) Pub. Date: Sep. 12, 2024

(54) CANOPY LIGHT

(71) Applicant: Jarvis Corp., Schaumburg, IL (US)

(72) Inventor: Kirby Corkill, Chicago, IL (US)

(21) Appl. No.: 18/601,830

(22) Filed: Mar. 11, 2024

Related U.S. Application Data
(60) Provisional application No. 63/451,523, filed on Mar. 10, 2023.

(51) Int. Cl. F21S 8/04; F21V 21/04; F21V 33/00; F21Y 105/12; F21Y 115/10

(52) U.S. Cl. CPC F21S 8/04; F21V 21/047; F21V 33/006; F21Y 2105/12; F21Y 2115/10

(57) ABSTRACT

A canopy light including a frame and a central lighting subassembly. The frame assembly has a central cavity. The central lighting subassembly has a plurality of LED's and a lens over the LED's. The central lighting subassembly is positionable in a plurality of different orientations relative to the central cavity of the frame body assembly.

### CROSS-REFERENCE TO RELATED APPLICATION

This application claim priority from U.S. Patent App. Ser. No. 63/451,523 entitled “Canopy Light”, filed Mar. 10, 2023, the entire disclosure of which is hereby incorporated by reference in its entirety.

### BACKGROUND OF THE DISCLOSURE

### 1. Field of the Disclosure

The disclosure relates in general to lighting fixtures, and more particularly, to a canopy light of the type that is typically utilized in association with canopies such as those found at gas stations and service centers, among other locations. Of course, the disclosure is not limited to any particular location of use.

### 2. Background Art

The use of canopy lighting is prevalent in a number of different environments. One such environment is a canopy of the type found at gas stations and service centers. In such locations, a canopy light is mounted typically to the underside of the canopy. Generally, such lighting is configured to provide illumination straight down, spread or directed in a direction that is oblique to the base of the canopy. Typically, it is necessary to provide specialized lighting for each such light dispersion pattern.

Problematically, it is often difficult to predict the desired light dispersion pattern that is desired for a particular canopy. In addition, it is often the case that over the lifetime of the use of the canopy light, it would be desirable to alter the light dispersion. Typically, such changes require the purchase of new canopy lights.

### SUMMARY OF THE DISCLOSURE

The disclosure, in one configuration, is directed to a canopy light comprising a frame body assembly and a central lighting subassembly. The frame body assembly has a housing with a central cavity opening in an outward direction. The central lighting subassembly has a plurality of LED's and a lens over the LED's. The central lighting subassembly is attachable to the housing so as to extend over the central cavity. The central lighting subassembly is attachable to the housing in fixed engagement with the frame body assembly in a plurality of different orientations relative to the central cavity of the frame body assembly.

In some configurations, in each of the orientations, the central lighting subassembly remains in the same plane.

In some configurations, the direction of the light emitted from the LED's is different in at least two of the plurality of different orientations.

In some configurations, the central cavity includes a perimeter defined by a plurality of sides so as to form a polygon. The central lighting subassembly includes a perimeter defined by a plurality of sides so as to form a central lighting subassembly polygon that corresponds to the polygon of the central cavity.

In some configurations, each of the sides of the polygon of the central cavity are of equal length, such that the central lighting subassembly can be positioned in as many different orientations relative to the central cavity, as the plurality of sides.

In some configurations, the polygon comprises an octagon.

In some configurations, the central lighting subassembly is attached to the housing through a plurality of fasteners that extend through the central lighting subassembly and into corresponding bores in the housing.

In some configurations, the housing includes a plurality of surrounding cavities extending between an outer perimeter of the housing and the central cavity. Additionally, a surrounding lighting subassembly is provided for each of the plurality of surrounding cavities.

In some configurations, the housing further includes a communication passageway between the central cavity and each of the plurality of surrounding cavities.

In some configurations, each of the surrounding lighting subassemblies include a plurality of LED's and a lens extending thereover.

In some configurations, the canopy light further includes a power supply positionable within the central cavity of the housing.

In some configurations, the housing includes a mounting side defining a base wall with a central post extending away from the base wall opposite the central cavity. The central post defines a bore in communication with the central cavity.

In some configurations, the canopy light further includes a covering plate extending over the mounting side of the housing, extending between the base wall and an outer perimeter of the housing.

In some configurations, the covering plate includes an outer surface which is coplanar with the base wall of the mounting side.

In some configurations, the housing includes a plurality of bores extending therethrough for attachment of the housing to an outside structure. The plurality of bores is spaced apart from the central cavity so as to be isolated therefrom.

In some configurations, the central lighting subassembly includes a base and a lens covering the base, with a plurality of LED's sandwiched therebetween, defining a unitary member.

In another aspect of the disclosure, the disclosure is directed to a method of altering a light of the canopy light. The canopy light is attached to an outside structure, wherein the housing of the canopy light is fixedly attached to the outside structure. The method comprises the steps of: detaching the central lighting subassembly from the housing; rotating the central lighting subassembly in an incremental rotation; and attaching the central lighting subassembly to the housing.

In some configurations, the central lighting subassembly is configured for attachment to the housing in at least two different configurations, such that light from the central lighting subassembly is directed in a different direction in each of the two different configurations.

In another aspect of the disclosure, the disclosure is directed to a system. The system comprises a canopy light and at least one additional central lighting subassembly. The at least one additional central lighting subassembly has a second lens, which is different than the lens of the central lighting subassembly. The central lighting subassembly is replaceable with the at least one additional central lighting subassembly.

In another aspect of the disclosure, the disclosure is directed to a method of altering a light of the canopy light having at least one additional central lighting subassembly, the method comprising the steps of: detaching the central lighting subassembly from the housing; one of replacing central lighting subassembly with at least one additional central lighting subassembly; and attaching the at least one additional central lighting subassembly to the housing.

### BRIEF DESCRIPTION OF THE DRAWINGS

The disclosure will now be described with reference to the drawings wherein:

FIG. 1 of the drawings is a perspective view of a configuration of the canopy light of the present disclosure, showing, a portion of the canopy to which the canopy light is mounted;

FIG. 2 of the drawings is an outward perspective view of a gas station having a plurality of pumps with a canopy extending over the pumps;

FIG. 3 of the drawings is a top plan view of a configuration of the canopy light of the present disclosure;

FIG. 4 of the drawings is a back perspective view of a configuration of the canopy light of the present disclosure;

FIG. 5 of the drawings is a perspective cross-sectional view of a configuration of the canopy light of the present disclosure, taken generally about lines 5-5 of FIG. 3;

FIG. 6 of the drawings is a perspective cross-sectional view of a configuration of the canopy light of the present disclosure, taken generally about lines 6-6 of FIG. 3;

FIG. 7 of the drawings is a top plan view of the housing of the frame body assembly of the canopy light of the present disclosure;

FIG. 8 of the drawings is a back perspective view of the housing of the canopy light of the present disclosure;

FIG. 9 of the drawings is a back perspective view of the lighting assemblies for use with the canopy light of the present disclosure;

FIG. 10 of the drawings is an outward perspective view of the central lighting subassembly of the canopy light of the present disclosure;

FIG. 11 of the drawings is a perspective cross-sectional view of the central lighting subassembly of the canopy light of the present disclosure;

FIG. 12 of the drawings is an exploded perspective view of the canopy light of the present disclosure;

FIG. 13a of the drawings is a top plan view of the canopy light showing a first dispersion of the central lighting assembly being focused in a downward direction;

FIG. 13b of the drawings is a top plan view of the canopy light showing a second dispersion of the central lighting assembly being generally symmetrically dispersing from the central lighting assembly in a wider pattern than that of FIG. 3a; and

FIG. 13c of the drawing is a top plan view of the canopy light showing a third dispersion of the central lighting assembly being directed to a side of the assembly, with the understanding that the central lighting assembly can be rotated through eight different (in the embodiment shown) positions to disperse light in different directions without remounting the canopy light.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

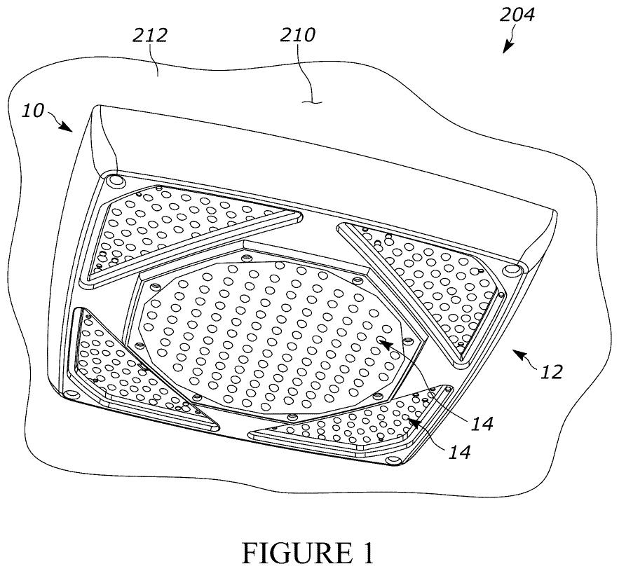

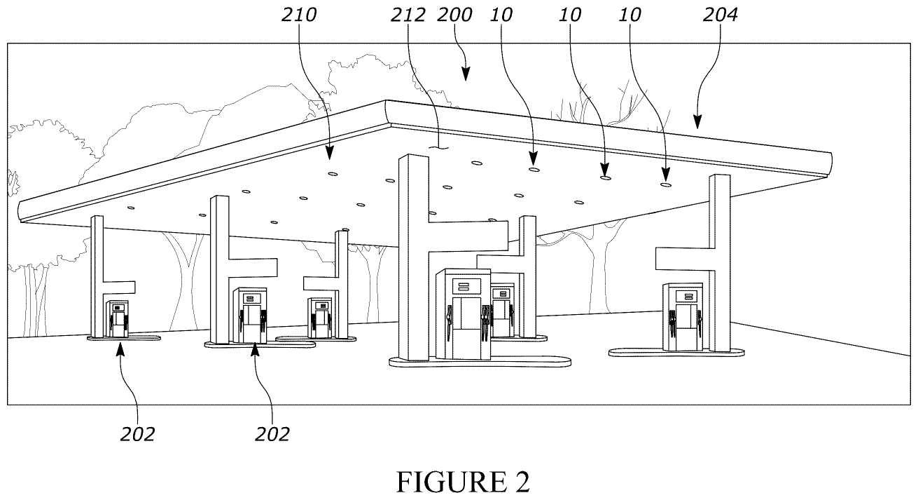

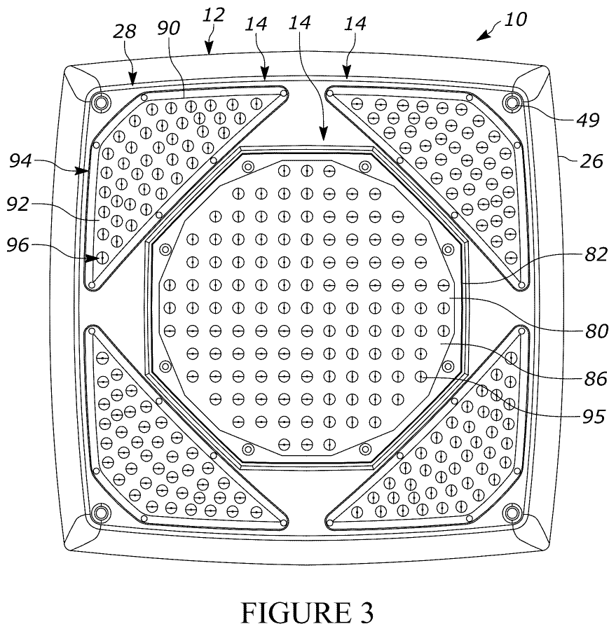

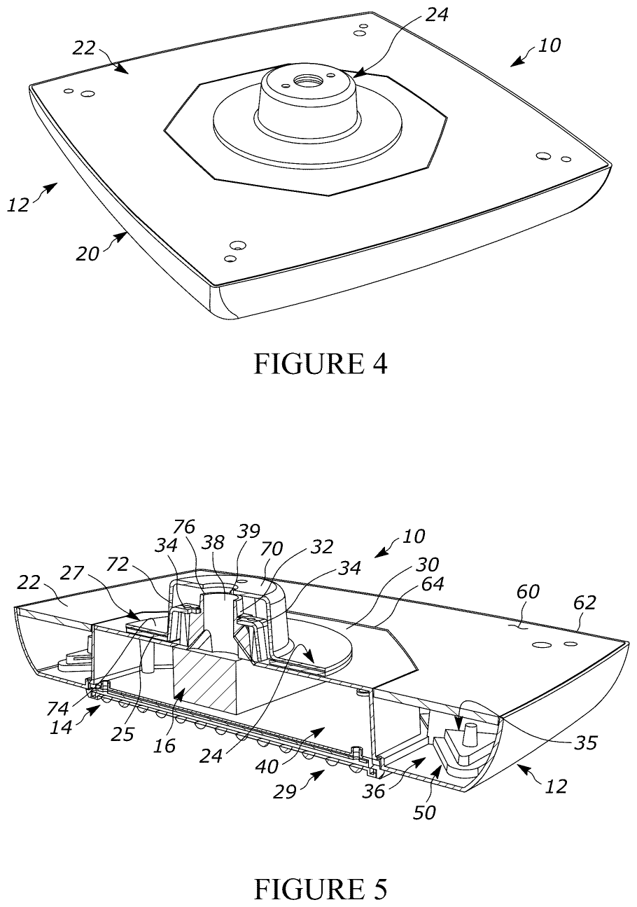

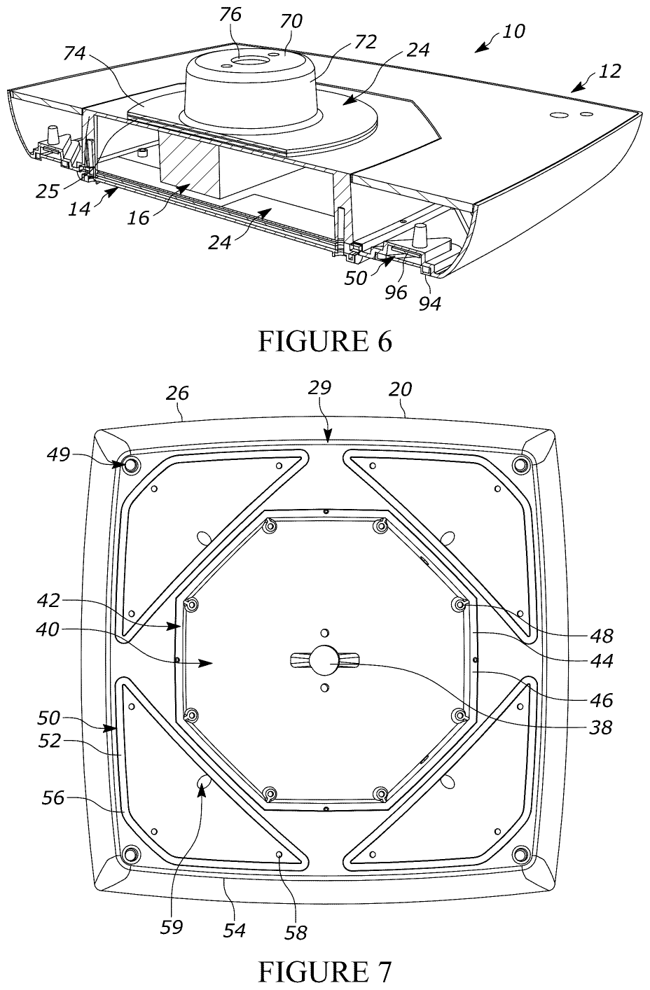

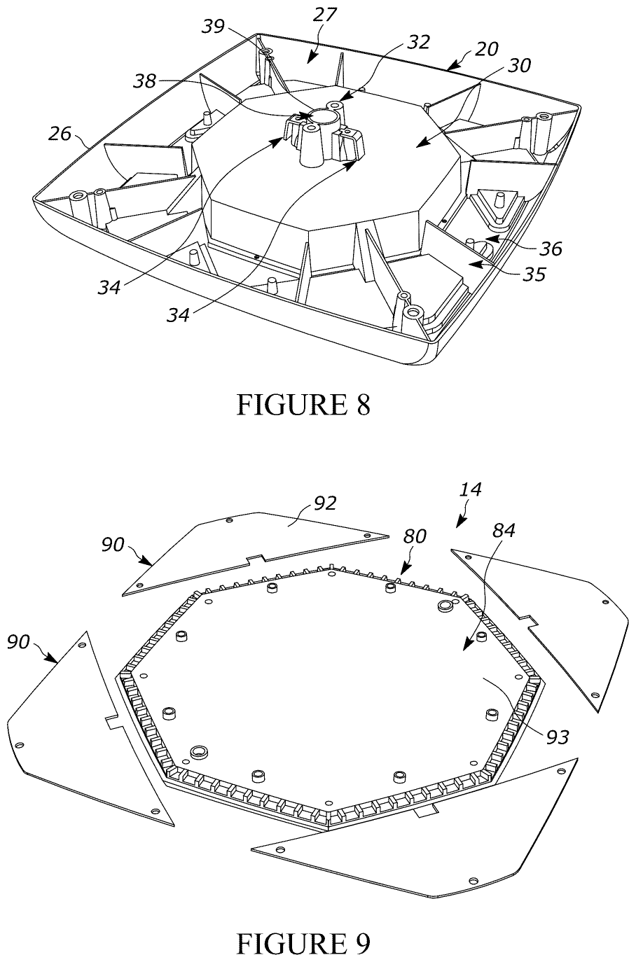

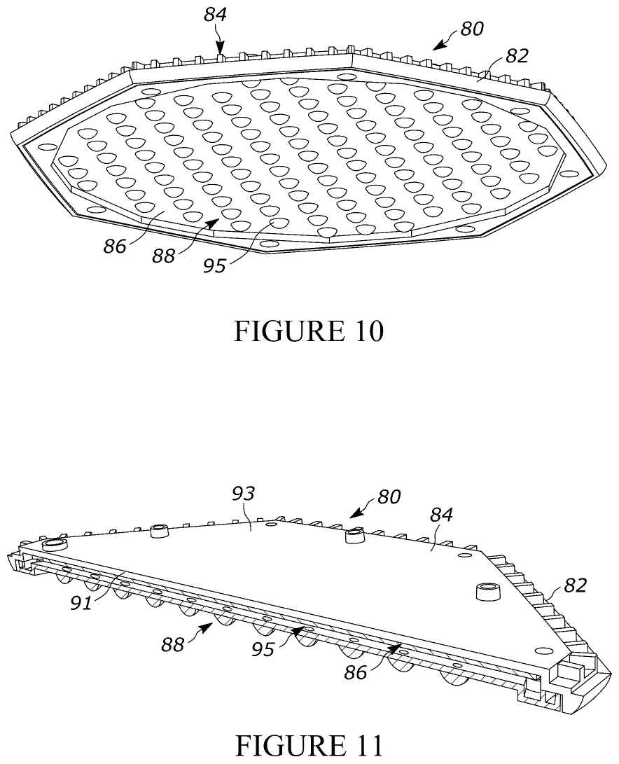

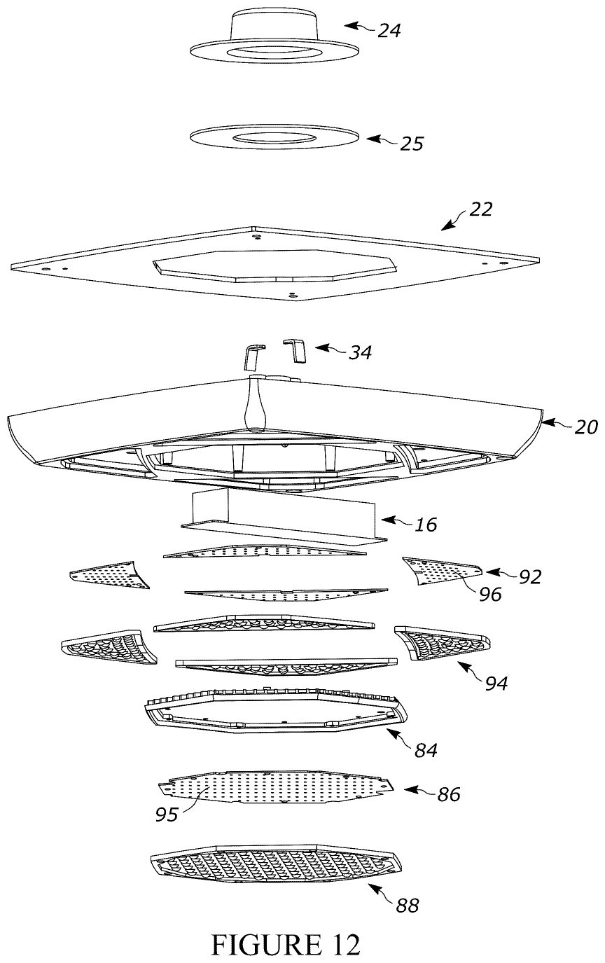

Referring now to the drawings and in particular to FIG. 1, the canopy light is shown generally at 10. The canopy light, as set forth above, can be found in any number of different locations, such as, for example, as canopy lighting for gas stations. More specifically, canopy light 10 may be utilized with gas station 200. Gas station 200 includes a plurality of pumps 202 which are covered by canopy 204. The canopy 204 includes ceiling 210 which has a facing surface 212 and an outer surface opposite thereto. In many such installations, the ceiling comprises a sheet metal that may be of thickness that is less than 3/16″. Of course, the use of the canopy light is not limited to use in association with gas stations, canopies of the type disclosed, much less any other particular location for use. And, of course, attachment to other configurations of gas stations, other canopies, and other structures is contemplated. That is, the location of use and the particular uses of the canopy light 10 is not to be deemed limiting.

The canopy light 10 includes frame body assembly 12, lighting assemblies 14 and power supply 16. In the configuration shown the frame body assembly 12 is shown as including housing 20, covering plate 22 and upper canopy housing member 24. As will be understood and explained below, housing 20 and cover plate 22 are typically mounted to one side of the ceiling of the canopy with a portion of the housing protruding through the canopy ceiling. The upper canopy housing member 24 is attached to housing 20 (and/or the covering plate 22) so as to sandwich the ceiling therebetween. A gasket, such as sealing gasket 25 can be positioned between the upper canopy housing member 24 and the opposite surface of the ceiling 210 of the canopy 204 of the gas station.

The housing 20 includes outer perimeter 26, mounting side 27 and lighting side 29. In the configuration shown, the outer perimeter is generally square or rectangular (with sides that may be slightly convex or concave), however, other outer configurations are contemplated. That is, the different walls of the generally square configuration may include simple and/or compound curves. In the configuration shown, the frame body assembly is generally formed from a molded member, such as a molded polymer member, while other materials, including, for example, cast or otherwise formed metal or metal alloy construction is likewise contemplated.

The mounting side 27 is configured for facing the facing surface of the canopy. The mounting side 27 includes base wall 30, central post 32, opposing clips 34 and outer cavities 26. The base wall is generally centrally located, with the outer cavities surrounding the base wall. A plurality of webs, such as webs 35 may divide the cavities and extend between each other, the base wall and the outer perimeter. The central post 32 extends outwardly from the base wall, terminating at distal end 39. The central post includes a bore 38. The opposing clips 34 are coupled to the central post and extend toward the base wall, terminating short of the base wall. The opposing clips are configured to flex inwardly so as to extend through an opening in the ceiling of the canopy (and to spring back outwardly), capturing the ceiling of the canopy between the opposing clips and the base wall.

The lighting side 29, which may be defined as the outward facing side (or the customer facing side) includes a central cavity 40, surrounding cavities, such as surrounding cavity 50 and communication passageways, such as communication passageway 59. The central cavity 40 is defined by a perimeter 42 that includes sides 44. The sides 44 may define a perimeter of any number of different shapes. Preferably, the sides 44 define a shape that has at least some symmetry (which will allow for the placement of the central lighting assembly 80 within the central cavity in at least a plurality of orientations). In the configuration shown, the perimeter 42 comprises eight sides (i.e., an octagon), allowing for the placement of the central lighting assembly 80 in eight different mounting orientations. It will be understood that while an octagon is shown, it will be understood that any number of different configurations are contemplated, some of which may comprise uniform shapes formed from linear sides, while others may be non-uniform, curved or arbitrary.

Additionally, sealing edge 46 may extend about the perimeter so as to provide a surface upon which a gasket may be positioned for sealed engagement. Furthermore, a plurality of fastener bores 48 are positioned so as to facilitate the securement of the central lighting subassembly thereto.

In the configuration shown, a total or four surrounding cavities 50 are disposed about the central cavity 40, and generally disposed in corners of the housing 20. In other configurations the surrounding cavities may partially or entirely surround the central cavity. Additionally, the different surrounding cavities may be of different configurations and of different sizes and shapes, without limitation. In the configuration shown, each of the surrounding cavities are substantially identical, such that, in the configuration shown, the lighting corner subassemblies can be identical or substantially identical in configuration. It will be understood that in some configurations, the surrounding cavities may be omitted from the configuration.

In the configuration shown, the surrounding cavities each include a perimeter 52 which defines typically, a plurality of sides 54 with the perimeter defining a sealing edge 56. Additionally, a plurality of fastener bores 58 are provided so that the surrounding lighting subassemblies can be mounted thereto.

Finally, a communication passageway, such as communication passageway 59 may be defined between each of the surrounding cavities 50 to the central cavity 40. Such a configuration allows for the wiring (not shown) to power and control the surrounding lighting assemblies can be directed into the central cavity for attachment to the power supply 16. It will be understood, advantageously, that the surrounding cavities once sealed with the surrounding lighting subassembly include only an opening, namely the communication passageway 59. The fastener bores are separated from the surrounding cavity so as to minimize the possibility of leaking. Similarly, the central opening includes only the openings of base wall for communication therebeyond, preferably. Thus, the central cavity is generally isolated fluidly.

Covering plate 22 may be positioned so as to extend between the base wall 30 and the outer perimeter 26 of the housing 20. In the configuration shown, the covering plate includes outer surface 60, outer perimeter 62 and inner perimeter 64. The outer perimeter 62 generally matches the outer perimeter 26. The inner perimeter 64 generally matches the outer perimeter of the base wall. The outer surface 60 is generally coplanar with the base wall. In the configuration shown, mounting bores 49 extend through both of the housing and the covering plate to facilitate attachment thereof to the outside structure (i.e., such as, for example, the ceiling of the canopy of the gas station).

Upper canopy housing 24 includes back wall 70, depending side 72 and base flange 74. The upper canopy housing is configured to cover the central post 32 and to facilitate coupling of the housing to the outside structure. As will be explained below, once the housing is positioned onto the ceiling of the canopy, and the central post extends through an opening of the ceiling, the upper canopy housing can be positioned thereover and fastened to the housing. In turn, the base flange 74 and the housing 20 sandwich the ceiling therebetween. A sealing gasket 25 may be provided so as to provide sealed engagement therebetween. The back wall 70 may include a central bore 76 which coincides with the bore 38 of the central post 32, to facilitate the extending of wiring and the like from the housing through the upper canopy housing.

The lighting assemblies 14 are generally formed from a central lighting subassembly 80 and a plurality of surrounding lighting subassemblies, such as surrounding lighting assembly 90. The central lighting assembly 80 includes perimeter 82, base 84, electronic board 86, a plurality of LED's 94 and lens 88. In the configuration shown, the central lighting assembly generally corresponds to the shape of the central cavity 40, while variations are contemplated. Thus, in the configuration shown, the perimeter 82 comprises an octagonal configuration. Of course, as set forth above with respect to the central cavity, a number of different shapes, configurations and sizes are contemplated. It is further contemplated that the central lighting subassembly may comprise multiple assemblies that can be configured relative to each other.

The base 84 includes top 90 and bottom 92. The board 86 may be positioned on the bottom 92 of the base with the lens 88 being positioned on the board 86 so that the lens can interact with the LED's 94 on the board 86. A plurality of openings may be disposed through the central lighting assembly 80, about the perimeter 82 thereof so as to allow for coupling of the central lighting assembly to the housing 20. It will be understood that the central lighting subassembly may include separate components, or a single integrated structure that is attached (through fasteners, adhesive or other structures) to each other.

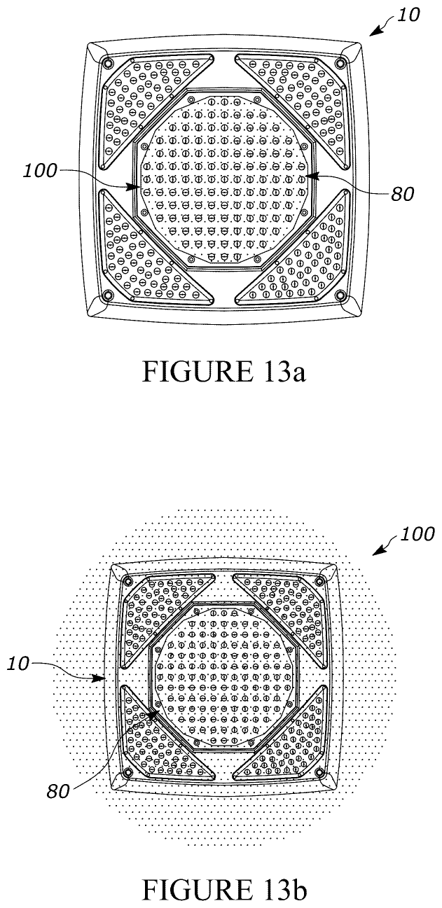

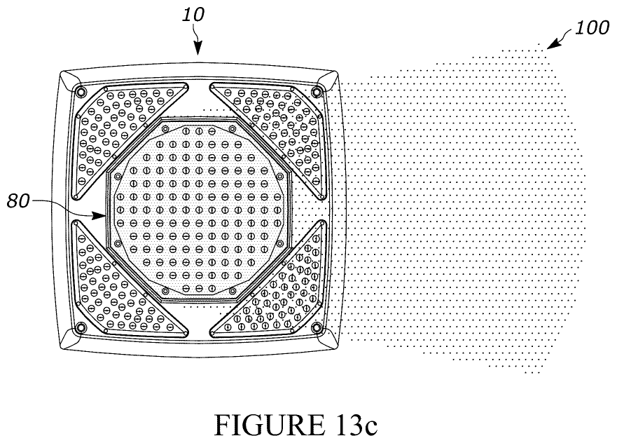

In the configuration shown, the lens 88 may comprise any one of a number of different lenses. For example, and as shown in FIG. 13a, the lens may direct light emission in a focused manner, generally perpendicular to the board. In other configurations, such as the configuration shown in FIG. 13b, the lens may direct light emission in a wider pattern than the focused manner, that is, the light may fan outwardly from the light source. In other configurations, such as the configuration shown in FIG. 13c, the lens may direct light emission in a particular direction, for example, in a direction that is angled toward one of the sides of the perimeter of the central lighting subassembly 80. In such a configuration, as the central lighting subassembly is positioned relative to the central cavity, the light can be directed in any one of eight different locations through the relative position of the central lighting subassembly relative to the central cavity of the frame body assembly (and remaining in the same plane in each orientation). The user can rotate the central lighting subassembly about an axis that is generally perpendicular to the central lighting subassembly a predetermined arcuate distance, and reattach (i.e., in the configuration shown, anywhere between an eighth of a turn and seven-eighths of a turn, in one-eighth of a turn increments, in either a clockwise or counter-clockwise direction). Other variations are likewise contemplated in addition to the three different examples set forth above, and the disclosure is not limited thereto.

In the configuration shown, the central cavity and the central lighting subassembly each define an octagon with eight equal sides. Other polygons, such as polygons having an odd or even number of sides, as well as other shapes are contemplated. Where polygons are utilized, preferably, each of the sides of the polygon, and the included angles are identical, such that the number of different orientations is equal to the number of sides of the polygon.

The surrounding lighting subassembly 90 is shown in FIG. 1 as comprising board 92 having LED's 96. Lens 94 extends over the board 92. It will be understood that the surrounding lighting subassemblies can be positioned in the surrounding cavities 28 of the frame body assembly. The lens 94 can provide any one of a number of different lenses so as to focus light outwardly, downwardly or otherwise.

It will be understood that the central lighting subassembly may be oriented so as to be substantially horizontal or substantially vertical, although orientations that are oblique are likewise contemplated. Typically, such lighting is mounted to the underside of a canopy. As for the surrounding cavities, they may be co-planar, parallel to or oblique relative to the central lighting assembly.

Power supply 16 (which may include a transformer or other electrical equipment known to those having skill in the art) may be provided within the central cavity 40. In other configurations, the power supply may be outside of the frame body assembly (i.e., in the canopy or other structure). In the configuration shown, the central lighting subassembly and the surrounding lighting subassemblies (i.e., the boards and LED's thereof) are electrically coupled to the power supply by extending wiring from the surrounding lighting subassemblies through the respective communication passageways to the central cavity. Similarly, the central lighting subassembly is electrically coupled to the power supply within the central cavity. Wiring extends from the power supply 16 through the base wall (and, in particular, through the bore 38 of the central post.

To mount the canopy light to an outside structure, in the configuration shown, such attachment can be made to, for example, a canopy of a gas station. In such a use, the canopy is provided with a ceiling that has an opening. The opening is sized so as to permit the passage of the central post 32 of the housing 20 therethrough. Preferably, the opening is smaller than the footprint of the opposing clips 34 so that as the opposing clips 34 reach the opening in the ceiling, the opposing clips are pushed inwardly so as to pass through the opening. Once on the opposite side of the opening, the opposing clips move outwardly, which precludes their passage through the opening.

Next, the user can place the upper canopy housing 24 over the central post 32 and then fasten the upper canopy housing to the central post 32 (or another component of the housing 20. Tightening of the structures (with sealing gasket 25 therebetween forms a substantially (if not fully) fluid tight seal therebetween, and further fixes the canopy light to the canopy. Once fully positioned as desired, it may be desirable to extend additional fasteners through the mounting bores 49 so as to further secure the canopy light to the canopy.

From time to time, the gas station (or other structure which has such lights illuminating the surroundings) may be reconfigured. In such instances, it may be desirable to alter the light pattern of the canopy light. Whereas, with other types of lights, it may be necessary to fully dismantle the light, or to replace the light, with the present disclosure, the central lighting subassembly can be decoupled from the housing 20 and may be fully removed and replaced with a central lighting subassembly having a different light directing path. In other configurations, it may only be necessary to rotate the central lighting subassembly relative to the housing so as to direct the light in the desired direction. In either instance, replacement of the canopy light is not required. Additionally, full and/or partial removal and disconnecting of the housing from the canopy is not required. In many instances, the configuration change can be accomplished by less skilled electrical operators and users than a full replacement of the canopy light.

It will be understood that the canopy light may be provided in a kit that includes the frame assembly and the lighting assembly, wherein a plurality of different central lighting subassemblies can be provided, each having the same or different pattern of light dispersion by having different lenses. Of course, different LED's may also be provided, so that the different patterns of light can be achieved.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A canopy light comprising:
a frame body assembly having a housing with a central cavity opening in an outward direction; and
a central lighting subassembly having a plurality of LED's and a lens over the LED's, the central lighting subassembly is attachable to the housing so as to extend over the central cavity;
wherein the central lighting subassembly is attachable to the housing in fixed engagement with the frame body assembly in a plurality of different orientations relative to the central cavity of the frame body assembly.

2. The canopy light of claim 1, wherein in each of the orientations, the central lighting subassembly remains in the same plane.

3. The canopy light of claim 1 wherein the direction of the light emitted from the LED's is different in at least two of the plurality of different orientations.

4. The canopy light of claim 1 wherein the central cavity includes a perimeter defined by a plurality of sides so as to form a polygon, and the central lighting subassembly includes a perimeter defined by a plurality of sides so as to form a central lighting subassembly polygon that corresponds to the polygon of the central cavity.

5. The canopy light of claim 4 wherein each of the sides of the polygon of the central cavity are of equal length, such that the central lighting subassembly can be positioned in as many different orientations relative to the central cavity, as the plurality of sides.

6. The canopy light of claim 4 wherein the polygon comprises an octagon.

7. The canopy light of claim 4 wherein the central lighting subassembly is attached to the housing through a plurality of fasteners that extend through the central lighting subassembly and into corresponding bores in the housing.

8. The canopy light of claim 1 wherein:
the housing includes a plurality of surrounding cavities extending between an outer perimeter of the housing and the central cavity; and
a surrounding lighting subassembly for each of the plurality of surrounding cavities.

9. The canopy light of claim 8 wherein the housing further includes a communication passageway between the central cavity and each of the plurality of surrounding cavities.

10. The canopy light of claim 8 wherein each of the surrounding lighting subassemblies include a plurality of LED's and a lens extending thereover.

11. The canopy light of claim 1 further comprising a power supply positionable within the central cavity of the housing.

12. The canopy light of claim 11 wherein the housing includes a mounting side defining a base wall with a central post extending away from the base wall opposite the central cavity, the central post defining a bore in communication with the central cavity.

13. The canopy light of claim 12 further comprising a covering plate extending over the mounting side of the housing, extending between the base wall and an outer perimeter of the housing.

14. The canopy light of claim 13 wherein the covering plate includes an outer surface which is coplanar with the base wall of the mounting side.

15. The canopy light of claim 1 wherein the housing includes a plurality of bores extending therethrough for attachment of the housing to an outside structure, the plurality of bores spaced apart from the central cavity so as to be isolated therefrom.

16. The canopy light of claim 1 wherein the central lighting subassembly includes a base and a lens covering the base, with a plurality of LED's sandwiched therebetween, defining a unitary member.

17. A method of altering a light of the canopy light of claim 1, wherein the canopy light is attached to an outside structure, wherein the housing of the canopy light is fixedly attached to the outside structure, the method comprising the steps of:
detaching the central lighting subassembly from the housing;
rotating the central lighting subassembly in an incremental rotation; and
attaching the central lighting subassembly to the housing.

18. The method of claim 17 wherein the central lighting subassembly is configured for attachment to the housing in at least two different configurations, such that light from the central lighting subassembly is directed in a different direction in each of the two different configurations.

19. A system comprising:
a canopy light comprising:
a frame body assembly having a housing with a central cavity opening in an outward direction; and
a central lighting subassembly having a plurality of LED's and a lens over the LED's, the central lighting subassembly is attachable to the housing so as to extend over the central cavity;
wherein the central lighting subassembly is attachable to the housing in fixed engagement with the frame body assembly in a plurality of different orientations relative to the central cavity of the frame body assembly; and
at least one additional central lighting subassembly, the at least one central lighting subassembly having a second lens, which is different than the lens of the central lighting subassembly,
wherein the central lighting subassembly is replaceable with the at least one additional central lighting subassembly.

20. A method of altering a light of the canopy light of the system of claim 19, wherein the canopy light is attached to an outside structure, wherein the housing of the canopy light is fixedly attached to the outside structure, the method comprising the steps of:
detaching the central lighting subassembly from the housing;
one of replacing central lighting subassembly with at least one additional central lighting subassembly; and
attaching the at least one additional central lighting subassembly to the housing.
